(19) United States
(12) Patent Application Publication
(10) Pub. No.: US 2013/0011605 A1
(43) Pub. Date: Jan. 10, 2013

(54) MANUFACTURE OF ARTICLES FORMED OF COMPOSITE MATERIALS

(75) Inventor: Zev MILLER, Shimshon (IL)

(73) Assignee: ISRAEL AEROSPACE INDUSTRIES LTD., Tel Aviv (IL)

(21) Appl. No.: 13/176,067

(22) Filed: Jul. 5, 2011

(51) Int. Cl. B32B 7/04; B32B 9/04; B32B 3/00; B32B 37/02

(52) U.S. Cl. 428/119; 156/182; 428/411.1; 428/172

(57) ABSTRACT

A method of manufacture of articles formed of composite materials including providing a plurality of elements, each of which is formed of a plurality of layers of composite material prepregs, assembling the plurality of elements in a desired mutual arrangement and applying heat and pressure to the plurality of elements following the assembling, thereby at least generally simultaneously to join the elements together and to cure at least some of the layers of composite materials.

### FIELD OF THE INVENTION

The present invention relates to the manufacture of articles formed of composite materials.

### BACKGROUND OF THE INVENTION

The following publications are believed to represent the current state of the art:

U.S. Pat. Nos. 4,591,400; 4,780,262; 4,693,678; 5,059,377; 5,087,187; 5,454,895; 5,772,950; 6,319,346; 6,561,459; 6,896,841; 7,676,923 and 7,681,835; and

U.S. Published Patent Application No. 2010/0166988.

### SUMMARY OF THE INVENTION

The present invention seeks to provide an improved method for manufacture of articles formed of composite materials.

There is thus provided in accordance with a preferred embodiment of the present invention a method of manufacture of articles formed of composite materials including providing a plurality of elements, each of which is formed of a plurality of layers of composite material prepregs, assembling the plurality of elements in a desired mutual arrangement and applying heat and pressure to the plurality of elements following the assembling, thereby at least generally simultaneously to join the elements together and to cure at least some of the layers of composite materials.

Preferably, the method also includes inserting at least one inflatable element between at least some of the plurality of elements prior to the applying heat and pressure. Additionally or alternatively, the plurality of elements include at least some elements which extend in mutually disparate directions. In accordance with a preferred embodiment of the present invention the plurality of elements include at least some elements which extend in at least nearly perpendicular directions.

There is also provided in accordance with another preferred embodiment of the present invention an article of manufacture including a plurality of elements, each formed of a plurality of layers of composite material prepregs, arranged in a desired mutual arrangement, the plurality of elements being joined together and cured by the application of heat and pressure.

In accordance with a preferred embodiment of the present invention the plurality of elements include at least some elements which extend in mutually disparate directions. Preferably, the plurality of elements include at least some elements which extend in at least nearly perpendicular directions.

### BRIEF DESCRIPTION OF THE DRAWINGS

The present invention will be understood and appreciated more fully from the following detailed description, taken in conjunction with the drawings in which:

FIG. 1 is a simplified illustration of an integral composite article constructed and operative in accordance with a preferred embodiment of the present invention;

FIGS. 2A, 2B and 2C are simplified illustrations of a method of manufacture of the integral composite article of FIG. 1 in accordance with an embodiment of the present invention;

FIG. 3 is a simplified illustration of another integral composite article constructed and operative in accordance with a preferred embodiment of the present invention; and

FIGS. 4A, 4B and 4C are simplified illustrations of a method of manufacture of the integral composite article of FIG. 3 in accordance with an embodiment of the present invention.

### DETAILED DESCRIPTION OF PREFERRED EMBODIMENTS

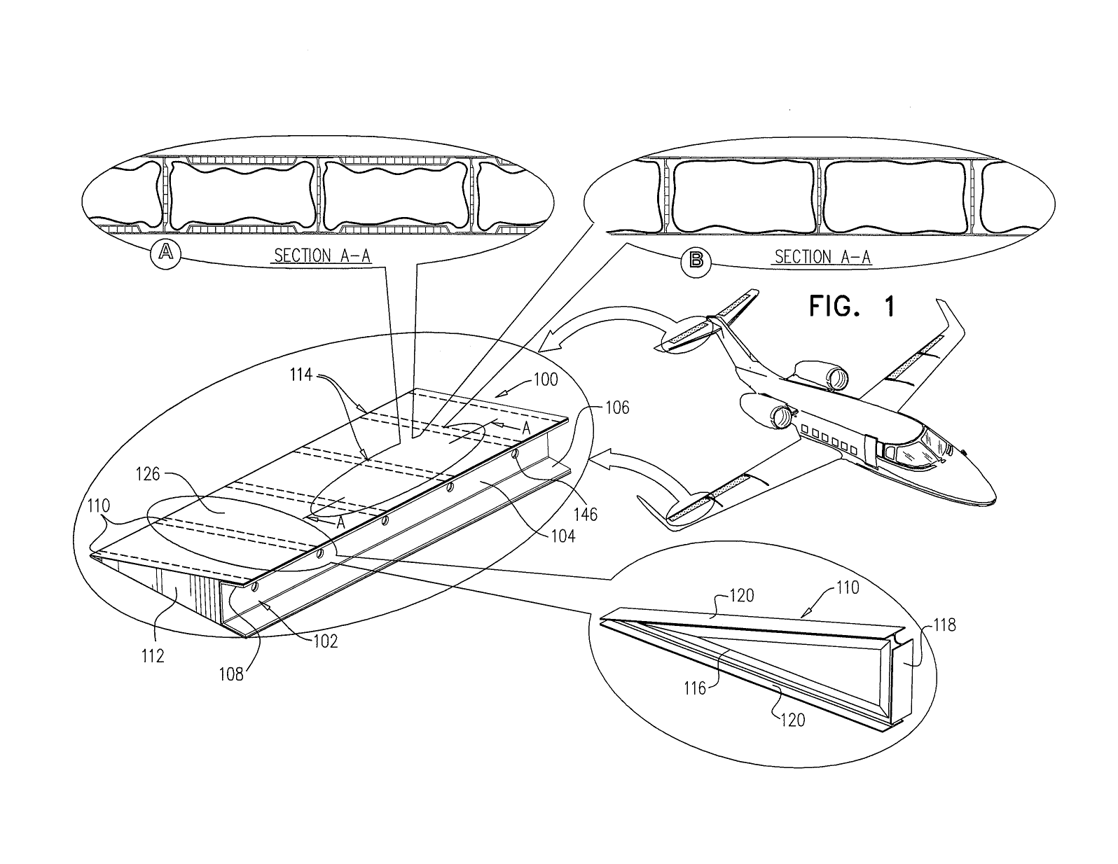

Reference is now made to FIG. 1, which is a simplified illustration of an integral composite article constructed and operative in accordance with a preferred embodiment of the present invention. As seen in FIG. 1, an integral composite article 100, here a control surface for an aircraft, such as an elevator, a rudder or an aileron, is formed with a spar 102, which may have any suitable configuration, and typically includes a web 104, integrally formed with flanges 106 and 108 as shown. Spar 102 is preferably prepared by conventional lay-up techniques used for composite materials but is preferably not cured prior to assembly in integral composite article 100. Spar 102 may be formed as solid laminate or as sandwich structure.

In accordance with a preferred embodiment of the present invention, a plurality of ribs 110 extend transversely and preferably perpendicularly to spar 102 and preferably include end ribs 112 and internal ribs 114. Ribs 110 are preferably prepared by conventional lay-up techniques used for composite materials but are preferably not cured prior to assembly in integral composite article 100. Ribs 110 may be foamed as solid laminates or as sandwich structures. Typically, the ribs are not cured until assembly together with the spar 102, but alternatively, they may include one or more cured portions.

As shown in an enlargement of part of FIG. 1, the ribs 110 preferably have an overall triangular configuration and include a generally triangular web 116 optionally having a sandwich construction, an end flange 118 and a pair of converging flanges 120.

An outer skin 126 extends over ribs 110 as well as spar flanges 106 and 108 to define an exterior configuration of article 100. Alternatively, spar 102 may be obviated and outer skin 126 is folded to replace web 104.

Outer skin 126 preferably includes a layup of pre-preg layers, which may or may not include a core and thus may be either a solid laminate or a sandwich. The typical overall thickness of outer skin 126 is approximately 1-4 mm for a solid laminate and approximately 5-15 mm for a sandwich. Outer skin 126 is preferably prepared by conventional lay-up techniques used for composite materials but is preferably not cured prior to assembly in integral composite article 100.

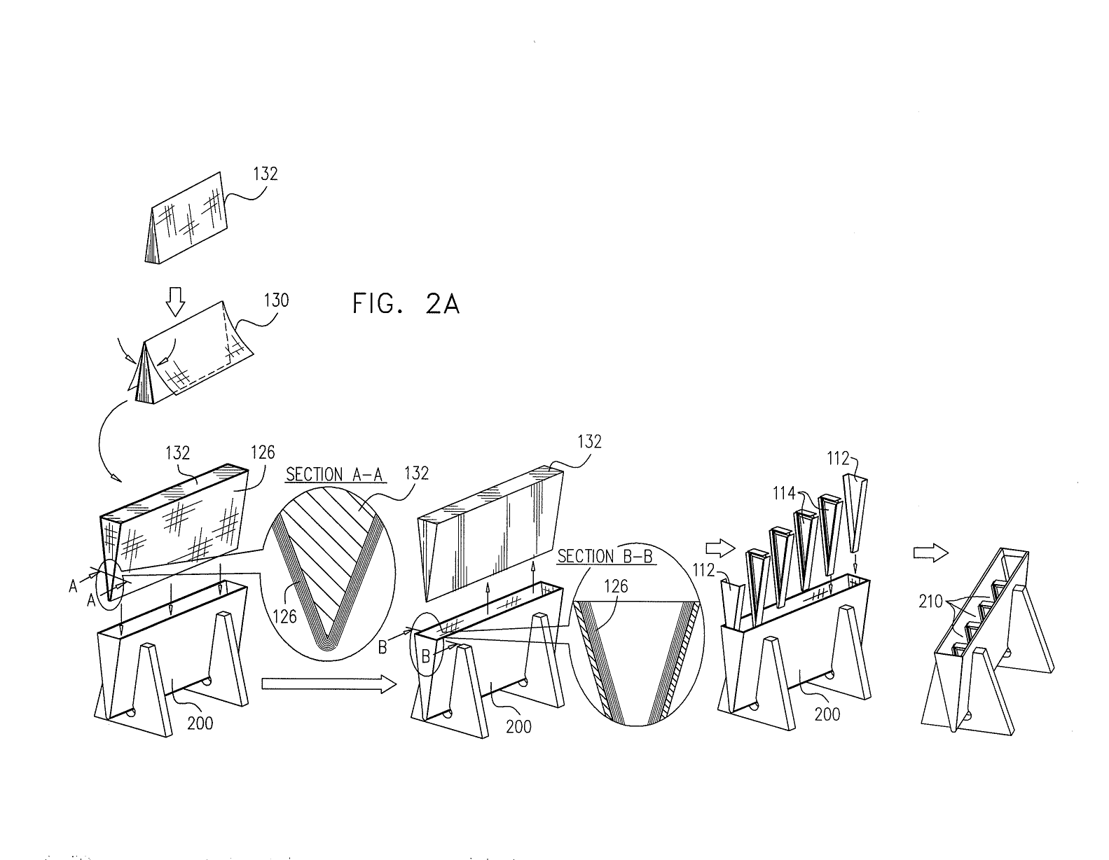

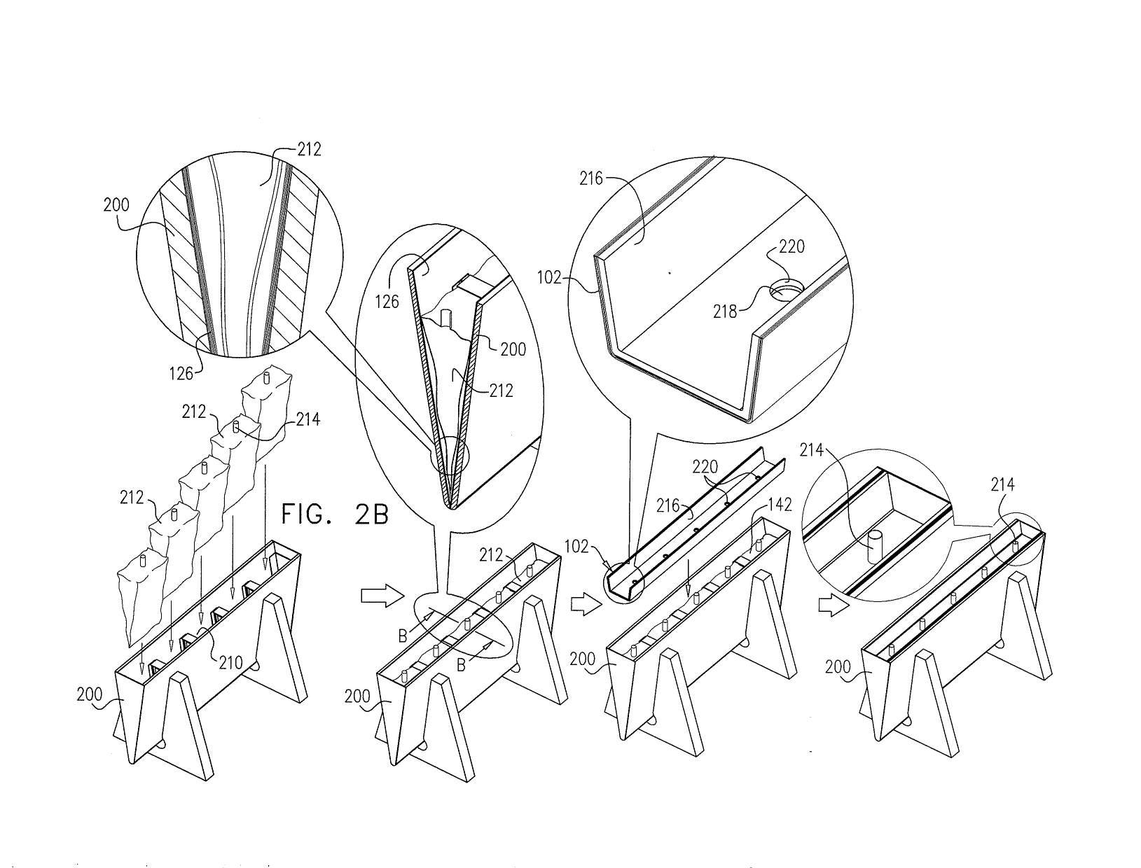

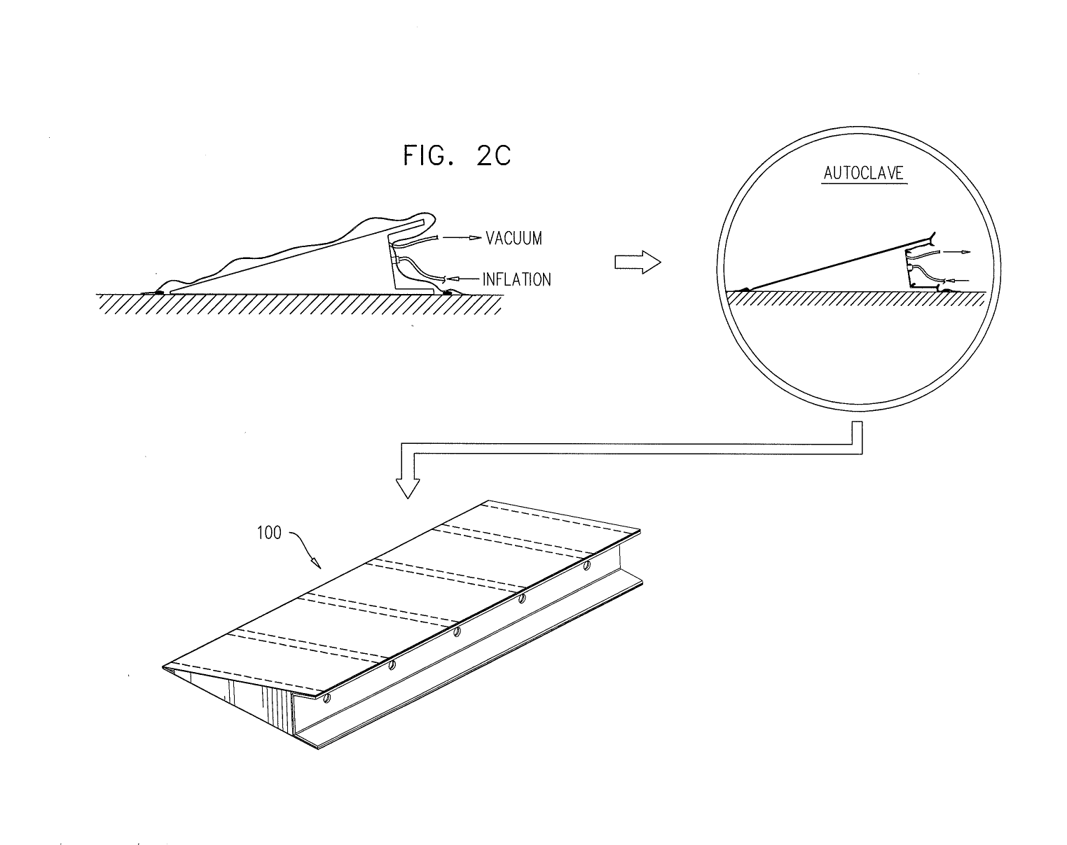

Reference is now made to FIGS. 2A-2C, which are simplified illustrations of a method of manufacture of an integral composite article, such as article 100 (FIG. 1) in accordance with an embodiment of the present invention. For convenience, the reference numerals used in FIG. 1 are also used in FIGS. 2A-2C, as appropriate.

As seen in FIG. 2A, the outer skin 126 is preferably produced in a conventional manner, by laying up multiple prepreg layers 130 on a wedge-shaped male tool 132. Following standard compaction, the outer skin 126 on tool 132 is placed in an article shape defining tool 200, having an open top and an inner configuration corresponding to the outer configuration of article 100. The term “compaction” is used throughout to refer to the application of pressure with or without heat and is also referred to as “debulking”. The wedge-shaped male tool 132 is subsequently removed from tool 200, leaving skin 126 inside tool 200, as shown.

Alternatively, wedge shaped tool 132 may be obviated and outer skin 126 may be layed up on a flat tool and subsequently folded to define a wedge shaped configuration. Outer skin 126 may be formed as a solid laminate or as a sandwich structure having a core. If a sandwich structure is employed, a multiple piece wedge shaped tool 132 may be required.

Thereafter, a plurality of ribs 110, including end ribs 112 and internal ribs 114, are placed in engagement with the outer skin 126 in tool 200.

Ribs 110 are preferably prepared using conventional prepreg layup techniques on shaped tools, followed by a conventional compaction process. It is appreciated that, while in the illustrated embodiment shown in FIGS. 1-2C, ribs 110 are removed from the shaped tools prior to being placed in outer skin 126, ribs 110 may be retained in the shaped tools until they are placed in outer skin 126 and subsequently the shaped tools are removed after each of ribs 110 is located in place.

In accordance with a preferred embodiment of the present invention, a plurality of inter-rib transverse volumes 210 are defined between adjacent ribs 110.

In accordance with a preferred embodiment of the present invention, as seen in FIG. 2B, a specifically configured inflatable element 212 is disposed in each of inter-rib transverse volumes 210. Each inflatable element 212 preferably includes an inflation tube 214.

It is appreciated that, while in the illustrated embodiment shown in FIGS. 1-2C, end flange 118 is formed in a direction transverse to web 116, in order to facilitate insertion of inflatable elements 212, end flange 118 may alternatively be formed of two side portions folded together, extending from web 116 in a generally parallel orientation thereto and including a separation layer, and, subsequent to the insertion of inflatable elements 212, folding back the side portions of end flange 118 to lie transversely to web 116.

Spar 102, together with a rigid spar shape defining tool 216 is then placed in tool 200 over ribs 110 and inflatable elements 212. Spar 102 is formed with apertures 218 for accommodating inflation tubes 214. Tool 216 is formed with apertures 220 which correspond in size and placement to apertures 218.

Turning now to FIG. 2C, it is seen that the inflatable elements 212 are inflated and vacuum is preferably applied to the volume between the outside of the inflatable elements 212 and the inside surface of outer skin 126, ribs 110 and spar 102, when located inside tool 200, and heat is applied. Typically, to ensure that the vacuum evacuates the air in tool 200 outside of the inflatable elements 212, conventional methods, such as including a breather layer, may be used.

It is a particular feature of the present invention that the resulting heat and pressure applied to spar 102, ribs 110 and outer skin 126 is sufficient not only to cure these elements but to close gaps therebetween and to create a positive pressure on respective mating surfaces that bonds the respective mating surfaces together, thereby integrating the structural parts into a unified structure. Typical pressures and temperatures applied are between 1 and 7 bar of pressure and between 100 degrees Centigrade and 190 degrees Centigrade.

This application of pressure, heat and vacuum may be realized by surrounding tool 200 with a vacuum bag and placing the tool and surrounding vacuum bag in an autoclave. In this embodiment using an autoclave, the pressure differential on external tool 200 during curing is relatively low compared to the pressure differential on tool 200 when not using an autoclave, so that in the embodiment using an autoclave, tool 200 may be of relatively lighter construction than necessary when not using an autoclave. Alternatively, the tool 200 may have integral heating elements and may be constructed to withstand the applied pressure of the inflatable elements 212. In such a case, the autoclave may be obviated. In another alternative embodiment, prepregs that cure at low pressures and do not require an autoclave are utilized to form composite article 100.

It is appreciated that the vacuum bag may be placed over tool 200 while tool 200 is lying on a flat tool, as shown in FIG. 2C. Alternatively, the vacuum bag may be placed over external tool 200 while tool 200 is placed in tool supports, such as the tool supports shown in FIG. 2B, thus obviating the need for a flat tool.

Following suitable curing and joining of spar 102, ribs 110 and outer skin 126, the article 100 inside tool 200 is allowed to cool in the autoclave. Alternatively, article 100 may be removed from the autoclave and allowed to cool at ambient temperature and pressure. The article 100 may then be removed from tool 200. Optionally inflatable elements 212 may be removed from the article via apertures 218 in spar 102. Alternatively, inflatable elements 212 may be retained in article 100, as shown, bonded to spar 102, ribs 110 and skin 126.

In an alternative embodiment, top and bottom portions of outer skin 126 may each be formed separately on a flat tool. In this embodiment, the bottom portion of outer skin 126 is then placed on a flat tool, followed by placing ribs 112 and 114, inflatable elements 212 and spar 102, together with a rigid spar shape defining tool 216, on the bottom portion of outer skin 126. The top portion of outer skin 126 is then placed over the bottom portion of outer skin 126, ribs 112 and 114, inflatable elements 212 and spar 102, while adding prepreg layers to splice top and bottom portions of outer skin 126 according to conventional splicing methods. The top portion of outer skin 126 is then covered with a top part of an article shape defining tool, effectively reaching the assembly shown in the final stage of FIG. 2B. Subsequently inflatable elements 212 are inflated and vacuum is applied as described hereinabove.

The composite article 100 may include a rounded leading edge portion (not shown) forward of spar 102, which may be assembled to the spar in a conventional manner by employing an inflatable element extending the length of the leading edge, which is inserted between the spar and the leading edge during curing of composite article 100. Additionally or alternatively, a wedge shaped portion may be included at the trailing edge of composite article 100.

It is appreciated that integral composite article 100 may also include ‘pad-ups’, which are local regions having increased thickness typically for providing increased local strength at points of attachment of associated components, such as supports, hinges and actuators. One realization of pad-ups employs discrete elements, which may be precured, but preferably are not cured and are thus assembled as part of the integral composite article 100 in accordance with an embodiment of the present invention. Alternatively, discrete metallic inserts may be included for pad-ups.

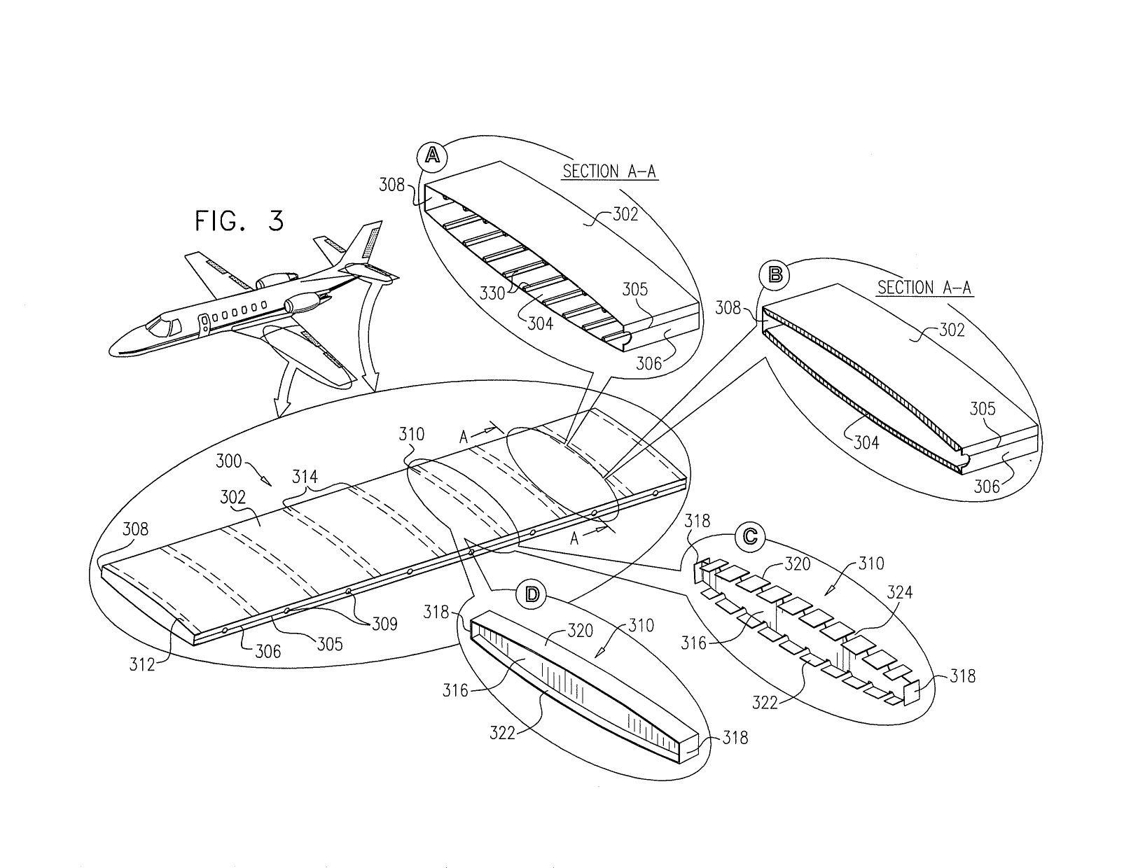

Reference is now made to FIG. 3, which is a simplified illustration of an integral composite article constructed and operative in accordance with another preferred embodiment of the present invention. As seen in FIG. 3, an integral composite article 300, here an aerodynamic surface for an aircraft, such as a wing, a horizontal stabilizer or a vertical stabilizer, is preferably formed with a top surface 302 and a bottom surface 304, having the external geometry of the main part of an aerodynamic contour, and typically includes a front spar 306 and a rear spar 308. It is appreciated that composite article 300 may have either a constant cross section or a varying cross section, in both vertical and transverse directions.

In the illustrated embodiment shown in FIG. 3, spars 306 and 308 are integrally formed as portions of top and bottom surfaces 302 and 304, and are attached as indicated by reference number 305. Alternatively, spars may be attached at any suitable location. Alternatively, spars 306 and 308 may be formed separately using conventional lay-up techniques used for composite materials, but are preferably not cured prior to assembly in integral composite article 300. At least one of spars 306 or 308 includes apertures 309 for the insertion of inflation tubes.

In accordance with a preferred embodiment of the present invention, a plurality of ribs 310 extend transversely and preferably perpendicularly to spars 306 and 308. Ribs 310 include internal ribs 314 and may also include end ribs 312. Ribs 310 are preferably prepared by conventional lay-up techniques used for composite materials. Ribs 310 may be formed as solid laminates or as sandwich structures. Typically the ribs 310 are not cured until assembly together with integral composite article 300, but alternatively, they may include one or more cured portions.

As shown in enlargements C and D of FIG. 3, ribs 310 preferably have an overall configuration designed to support the aerodynamic contour of surfaces 302 and 304, and include a generally oval shaped web 316, optionally having a sandwich construction, end flanges 318 and top and bottom flanges 320 and 322. As seen in respective enlargements C and D, flanges 320 and 322 of internal ribs 314 may be formed with or without cutouts 324. It is appreciated that flanges 320 and 322 of end ribs 312 are typically formed without cutouts, and are typically formed on only one side of web 316.

It is appreciated that, in integral composite article 300, end flanges 318 are joined to spars 306 and 308 and top and bottom flanges 320 and 322 are respectively joined to top surface 302 and bottom surface 304.

In accordance with a preferred embodiment of the present invention, as seen in enlargement A, integral composite article 300 also includes stiffening elements 330, such as stringers, to prevent buckling of surfaces 302 and 304 when subject to compressive and/or shear loads. Alternatively, as seen in enlargement B, surfaces 302 and 304 have a sandwich construction and stiffening elements 330 are obviated.

Top and bottom surfaces 302 and 304 extend over ribs 310 to define, together with spars 306 and 308, an exterior configuration of article 300. As described hereinabove, spars 306 and 308 may be integrally formed with top and bottom surfaces 302 and 304. Alternatively, spars 306 and 308 may be formed as separate parts from top and bottom surfaces 302 and 304.

Top and bottom surfaces 302 and 304 each preferably include a layup of pre-preg layers, which may or may not include a core and thus may be either a solid laminate or a sandwich. The typical overall thickness of top and bottom surfaces 302 and 304 is approximately 1-10 mm for a solid laminate and approximately 5-25 mm for a sandwich. Top and bottom surfaces 302 and 304 are preferably prepared by conventional lay-up techniques used for composite materials but are preferably not cured prior to assembly in integral composite article 300.

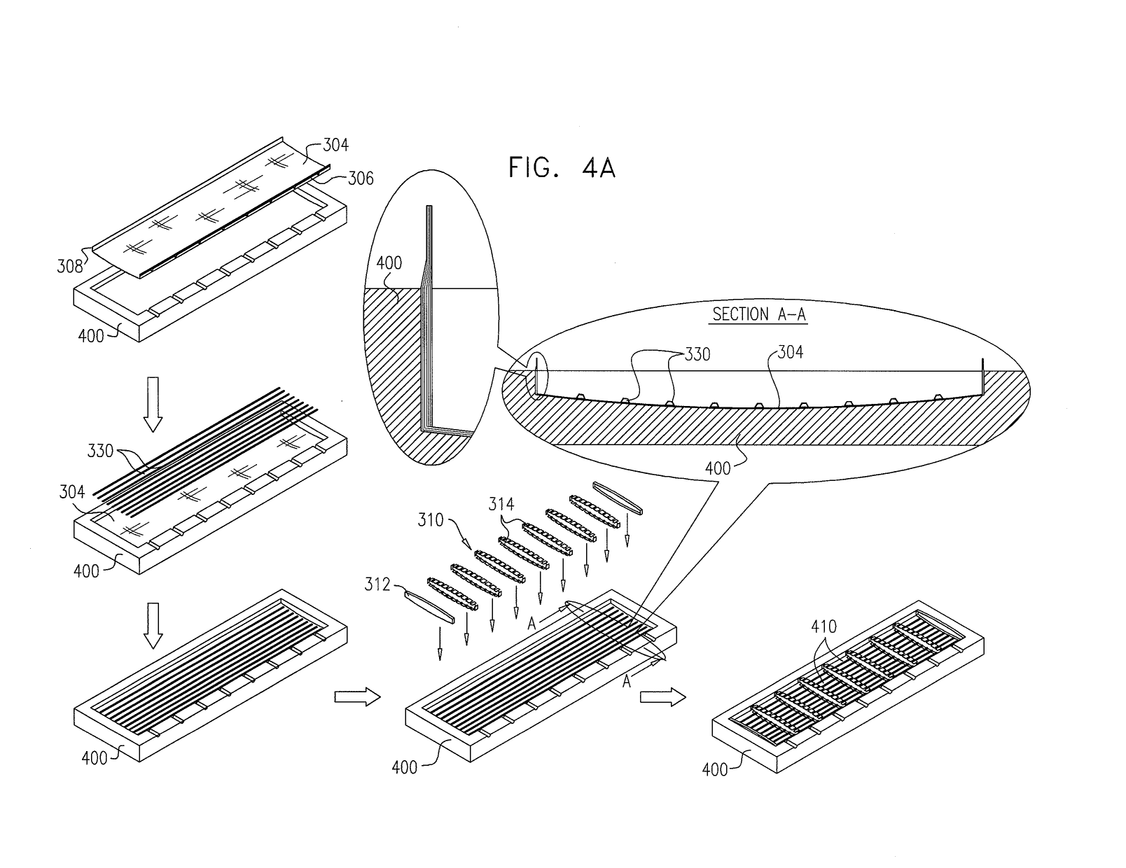

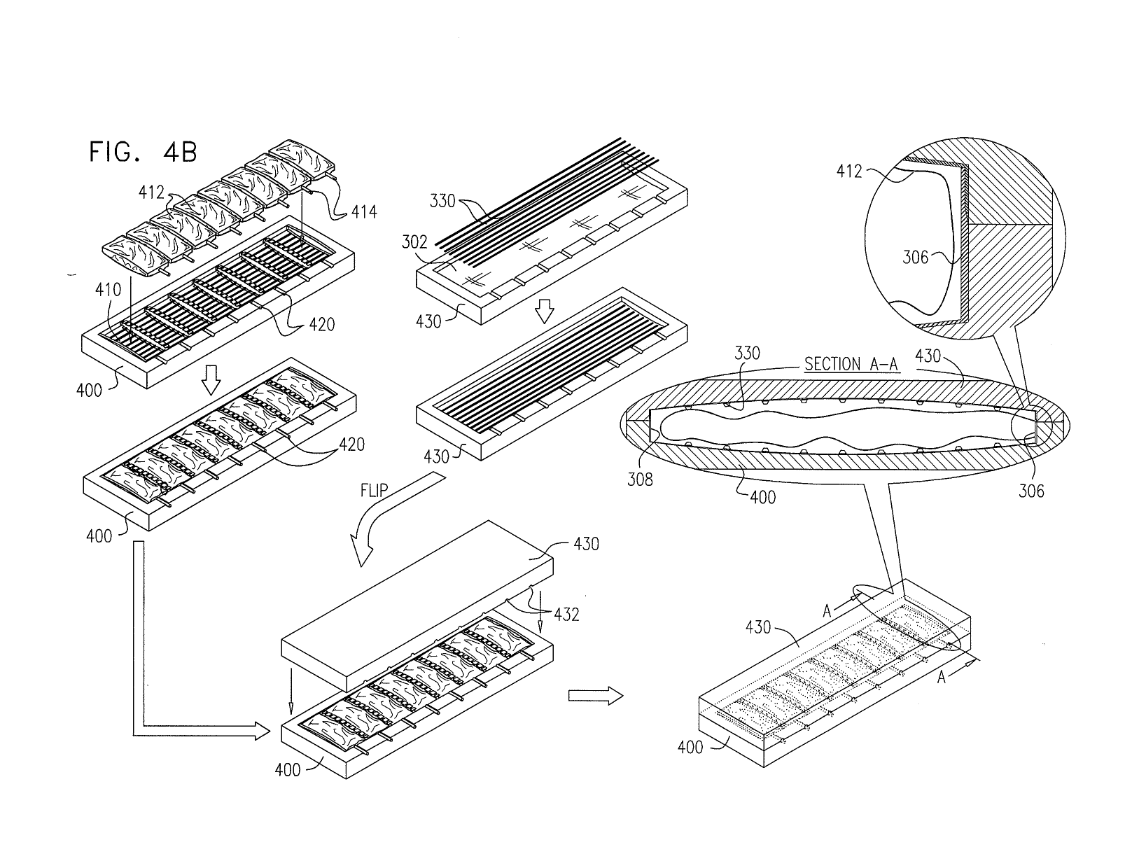

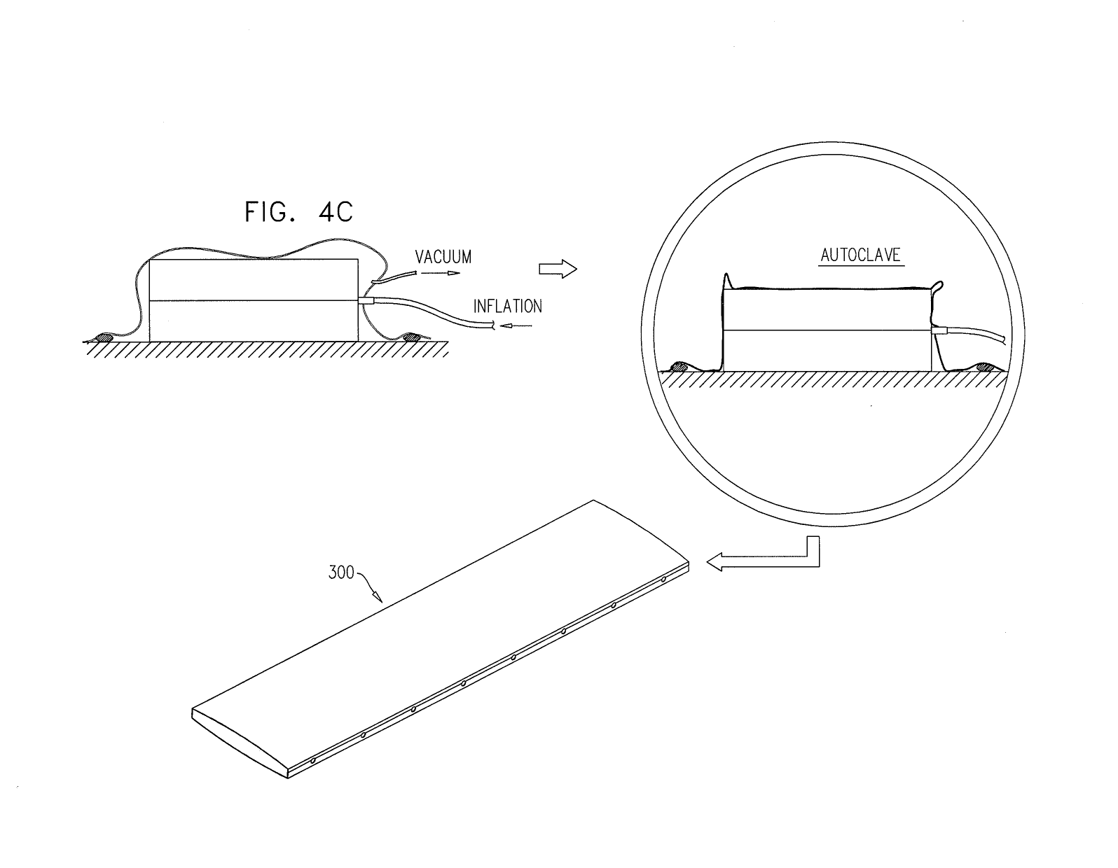

Reference is now made to FIGS. 4A-4C, which are simplified illustrations of a method of manufacture of an integral composite article, such as article 300 (FIG. 3) in accordance with an embodiment of the present invention. For convenience, the reference numerals used in FIG. 3 are also used in FIGS. 4A-4C, as appropriate.

As seen in FIG. 4A, bottom surface 304 is preferably produced in a conventional manner, by laying up multiple prepreg layers on a male tool (not shown) that has the required external aerodynamic contour. Following standard compaction, the bottom surface 304 on the male tool is placed in a bottom half of a composite article shape defining tool 400, having an open top and an inner configuration corresponding to the outer configuration of composite article 300. The male tool is subsequently removed from bottom half shape defining tool 400, leaving surface 304 generally inside bottom half shape defining tool 400, as shown.

Alternatively, male shaped tool may be obviated and bottom surface 304 may be directly laid up in bottom half shape defining tool 400. Alternatively, bottom surface 304 may be formed on a flat tool and subsequently folded to obtain the required shape including the spars 306 and 308. Bottom surface 304 may be formed as a solid laminate or as a sandwich structure having a core.

In the illustrated embodiment shown in FIG. 4A, the bottom portion of spars 306 and 308 are integrally formed with bottom surface 304. Spar 306 preferably also includes apertures 309. Alternatively, apertures may be in spar 308.

Thereafter, a plurality of stiffening elements 330 are placed on bottom surface 304. In a preferred embodiment, stiffening elements 330 are formed and precured prior to placement on bottom surface 304. The size and cross section of stiffening elements 330 are configured so that the pressure caused by inflation of the inflatable elements will not cause the stiffening elements 330 to collapse, and are also configured to ensure that stiffening elements 330 will maintain sufficient pressure on bottom surface 304 during the curing process. While in the illustrated embodiment trapezoidal shaped stiffening elements 330 are shown, stiffening elements 330 may be any other suitable shape, such as semi-circular or triangular. Additionally or alternatively, foam filled stiffening elements 330 with suitable properties may be provided.

Alternatively, as shown in enlargement B of FIG. 3, bottom surface 304 may be formed with a sandwich construction, and stiffening elements 330 are obviated.

Thereafter, a plurality of ribs 310, including end ribs 312 and internal ribs 314, are placed in engagement with the bottom surface 304 and bottom portions of spars 306 and 308 in bottom half shape defining tool 400. As seen in FIG. 3, flanges 320 and 322 of internal ribs 314 include cutouts 324 to allow passage of stiffening elements 330 through cutouts 324.

Ribs 310 are preferably prepared using conventional prepreg layup techniques on shaped tools, followed by a conventional compaction process.

As described hereinabove, in the alternative embodiment shown in enlargement B of FIG. 3, in which top and bottom surfaces 302 and 304 have a sandwich construction and stiffening elements 330 are obviated, internal ribs 314 are formed without cutouts 324, as shown in enlargement D of FIG. 3.

In accordance with a preferred embodiment of the present invention, a plurality of inter-rib transverse volumes 410 are defined between adjacent ribs 310.

In accordance with a preferred embodiment of the present invention, as seen in FIG. 4B, a specifically configured inflatable element 412 is disposed in each of inter-rib transverse volumes 410. Each inflatable element 412 preferably includes an inflation tube 414. Inflation tubes 414 are accommodated by apertures 309 of front spar 306. Bottom half shape defining tool 400 is formed with cutouts 420 to accommodate inflation tubes 414.

It is appreciated that, in the embodiment illustrated in FIGS. 4A-4C, where bottom portion of spar 306 is integrally formed with bottom surface 304, apertures 309 may be formed as cutouts in bottom portion of spar 306 to facilitate placement of inflation tubes 414, and top portions of apertures 309 are formed in top portion of spar 306 integrally formed with top surface 302.

Top surface 302, preferably also including top portions of spars 306 and 308, is preferably formed in a manner similar to bottom surface 304 and placed in a top half of a composite article shape defining tool 430. Shape defining tool 430 is formed with cutouts 432 to accommodate inflation tubes 414. Cutouts 432 are located to correspond to apertures 309 in spar 306.

Thereafter, a plurality of stiffening elements 330 are placed on top surface 302 in top half shape defining tool 430, and held in place by performing standard compaction to top surface 302 and stiffening elements 330. In a preferred embodiment, stiffening elements 330 are conventional stiffening elements. The size and cross section of stiffening elements 330 are configured so that the pressure caused by inflation of inflatable elements 412 will not cause the stiffening elements 330 to collapse, and are also configured to ensure that stiffening elements 330 will maintain sufficient pressure on top surface 306 during the curing process. While in the illustrated embodiment trapezoidal shaped stiffening elements 330 are shown, stiffening elements 330 may be any other suitable shape, such as semi-circular or triangular. Alternatively, as shown in enlargement B of FIG. 3, top surface 306 may be formed with a sandwich construction, and stiffening elements 330 are obviated.

Subsequently, top surface 302, including top portions of spars 306 and 308, with stiffening elements 330 and top half shape defining tool 430 are placed over ribs 310 and inflatable elements 412 and bottom portions of spars 306, 308 in bottom half shape defining tool 400. Alternatively, as shown in enlargement B of FIG. 3, top surface 302 may have sandwich construction and stiffening elements 330 are obviated.

Turning now to FIG. 4C, it is seen that the inflatable elements 412 are inflated and vacuum is preferably applied to the volume between the outside of the inflatable elements 412 and the inside surface of top and bottom surfaces 302 and 304, ribs 310 and integral spars 306 and 308, when located inside tools 400 and 430, and heat is applied.

It is a particular feature of the present invention that the resulting heat and pressure applied to surfaces 302 and 304, spars 306 and 308 and ribs 310 is sufficient not only to cure these elements but to close gaps therebetween and create a positive pressure on respective mating surfaces that bonds the mating surfaces together and also bonds stiffening elements 330 to surfaces 302 and 304. Thus, the structural parts are integrated into a unified structure. Typical pressures and temperatures applied are between 1 and 7 bar of pressure and between 100 degrees Centigrade and 190 degrees Centigrade.

This application of pressure, heat and vacuum may be realized by surrounding tools 400 and 430 with a vacuum bag and placing the tool and surrounding vacuum bag in an autoclave. Alternatively, tools 400 and 430 may have integral heating elements and may be constructed to withstand the applied pressure of the inflatable elements 412. In such a case, the autoclave may be obviated. In another alternative embodiment, prepregs that cure at low pressures and do not require an autoclave are utilized to form composite article 300.

Following suitable curing and joining of surfaces 302 and 304, spars 306, 308, ribs 310 and stiffening elements 330, composite article 300 inside tools 400 and 430 is allowed to cool in the autoclave. Alternatively, composite article 300 may be removed from the autoclave and allowed to cool at ambient temperature and pressure. Composite article 300 may then be removed from tools 400 and 430. Optionally, inflatable elements 412 may be removed from the article via apertures 309 in spar 306. Alternatively, inflatable elements 412 may be retained in composite article 300, as shown, bonded to surfaces 302 and 304, integral spars 306 and 308, ribs 310 and stiffening elements 330.

In another alternative embodiment, composite article 300 includes a rounded leading edge portion forward of spar 306 and/or a trailing edge portion rearward of spar 308. In this embodiment, the required leading edge layup or trailing edge layup is added contiguously with spar 306 and/or spar 308, respectively, and an inflatable element extending the length of the leading edge and/or the trailing edge is then inserted during curing of composite article 300.

It is appreciated that integral composite article 300 may also include ‘pad-ups’, which are local increases in the thickness of the components of composite article 300, typically providing increased local strength at attachment points such as joints, hinges and actuator attachment points. Alternatively, local increases in strength may be provided by adding separate local strengthening elements. The local strengthening elements may be precured, but preferably are not cured prior to assembly in integral composite article 300. Alternatively, discrete metallic inserts may be included for pad-ups.

It is appreciated that stiffening elements, such as stiffening elements 330 shown in the embodiment of FIGS. 3-4C or other suitable stiffening elements, may also be utilized in the formation of composite article 100, arranged in either a longitudinal or a transverse direction.

The present invention is applicable in various additional industries, such as building construction and automotive manufacturing. It will be appreciated by persons skilled in the art that the present invention is not limited by what has been particularly shown and described hereinabove. Rather the scope of the present invention includes both combinations and subcombinations of the various features described hereinabove as well as modifications and variations thereof which are not in the prior art.

1. A method of manufacture of articles formed of composite materials comprising the steps of:
providing a plurality of elements, each of which is formed of a plurality of layers of composite material prepregs;
assembling said plurality of elements in a desired mutual arrangement; and
applying heat and pressure to said plurality of elements following said assembling, thereby at least generally simultaneously to join said elements together and to cure at least some of said layers of composite materials.

2. A method of manufacture of articles according to claim 1 and also comprising inserting at least one inflatable element between at least some of said plurality of elements prior to said applying heat and pressure.

3. A method of manufacture of articles according to claim 2 and wherein said plurality of elements include at least some elements which extend in mutually disparate directions.

4. A method of manufacture of articles according to claim 3 and wherein said plurality of elements include at least some elements which extend in at least nearly perpendicular directions.

5. A method of manufacture of articles according to claim 1 and wherein said plurality of elements include at least some elements which extend in mutually disparate directions.

6. A method of manufacture of articles according to claim 5 and wherein said plurality of elements include at least some elements which extend in at least nearly perpendicular directions.

7. An article of manufacture comprising:
a plurality of elements, each formed of a plurality of layers of composite material prepregs, arranged in a desired mutual arrangement, said plurality of elements being joined together and cured by the application of heat and pressure.

8. An article of manufacture according to claim 7 and wherein said plurality of elements include at least some elements which extend in mutually disparate directions.

9. An article of manufacture according to claim 8 and wherein said plurality of elements include at least some elements which extend in at least nearly perpendicular directions.
